(19) United States
(12) Patent Application Publication
(10) Pub. No.: US 2017/0045992 A1
(43) Pub. Date: Feb. 16, 2017

(54) Capacitive Force Sensing Touch Panel

(71) Applicant: Raydium Semiconductor Corporation, Hsinchu (TW)

(72) Inventors: Kun-Pei Lee, Taichung City (TW); Yi-Ying Lin, Hualien City (TW); Hsin-Wei Shieh, New Taipei City (TW); Chang-Ching Chiang, Taichung City (TW); Yu-Chin Hsu, Hsinchu City (TW)

(21) Appl. No.: 15/233,077

(22) Filed: Aug. 10, 2016

Related U.S. Application Data
(60) Provisional application No. 62/203,451, filed on Aug. 11, 2015.
(60) Provisional application No. 62/213,162, filed on Sep. 2, 2015.
(60) Provisional application No. 62/258,830, filed on Nov. 23, 2015.

(51) Int. Cl. G06F 3/041; G06F 3/044

(52) U.S. Cl. CPC G06F 3/0416; G06F 3/0414; G06F 3/044; G06F 3/0412

(57) ABSTRACT

A capacitive force sensing touch panel is disclosed. The capacitive force sensing touch panel includes a plurality of pixels. A laminated structure of each pixel includes a first plane, a second plane, at least a first electrode and at least a second electrode. The second plane is disposed above the first plane and parallel to the first plane. The at least one first electrode is disposed on the first plane. The at least one second electrode is disposed on the second plane. The at least one first electrode and the at least one second electrode are selectively driven as touch sensing electrodes or force sensing electrodes respectively.

### BACKGROUND OF THE INVENTION

1. Field of the Invention

This invention relates to a touch panel, especially to a capacitive force sensing touch panel.

2. Description of the Prior Art

In general, if capacitive touch electrodes in a capacitive touch panel are also used to be force sensing electrodes at the same time, such as the sensing electrode SE in FIG. 1 is disposed on the upper substrate 12. And, the reference electrode RE can be disposed on the lower substrate 10 in FIG. 1.

When the upper substrate 12 is pressed by a finger, because the distance d between the sensing electrode SE on the upper substrate 12 and the reference electrode RE on the lower substrate 10 will be changed based on different forces provided by the finger, the capacitance sensed between the sensing electrode SE and the reference electrode RE will be also changed accordingly.

However, the capacitive touch sensing signal will be also changed based on different finger pressing areas. When the finger press the touch panel downward, the finger pressing area will be increased and the sensed capacitance will be also changed accordingly. Therefore, the force sensing determined according to capacitance variation will be also affected and it is hard to obtain accurate force sensing result.

### SUMMARY OF THE INVENTION

Therefore, the invention provides a capacitive force sensing touch panel to effectively solve the above-mentioned problems.

An embodiment of the invention is a capacitive force sensing touch panel. In this embodiment, the capacitive force sensing touch panel includes a plurality of pixels. A laminated structure of each pixel includes a first plane, a second plane, at least a first electrode and at least a second electrode. The second plane is disposed above the first plane and parallel to the first plane. The at least one first electrode is disposed on the first plane. The at least one second electrode is disposed on the second plane. The at least one first electrode and the at least one second electrode are selectively driven as touch sensing electrodes or force sensing electrodes respectively.

In an embodiment, only the at least one first electrode disposed on the first plane or the at least one second electrode disposed on the second plane is driven as the touch sensing electrode to form a self-capacitive structure.

In an embodiment, the at least one first electrode disposed on the first plane and the at least one second electrode disposed on the second plane are both driven as the touch sensing electrodes to form a mutual-capacitive structure.

In an embodiment, only the at least one first electrode disposed on the first plane or the at least one second electrode disposed on the second plane is driven as the force sensing electrode.

In an embodiment, the at least one first electrode disposed on the first plane and the at least one second electrode disposed on the second plane are both driven as the force sensing electrodes.

In an embodiment, the first plane and the second plane are two different planes of the same substrate or planes of two different substrates respectively.

In an embodiment, the at least one first electrode disposed on the first plane is driven as the force sensing electrode and the at least one second electrode disposed on the second plane is driven as the touch sensing electrode, so that the touch sensing electrode is disposed above the force sensing electrode.

In an embodiment, when the capacitive force sensing touch panel is pressed by a force, a distance between the at least one second electrode disposed on the second plane and the at least one first electrode disposed on the first plane is changed to sense a capacitance variation between the at least one first electrode and the at least one second electrode.

In an embodiment, the at least one first electrode disposed on the first plane is driven as a touch sensing electrode by a touch signal, but the at least one second electrode corresponding to a force sensing position receives a ground level or a floating level to be a shielding electrode of a part of the at least one first electrode; when the capacitive force sensing touch panel is pressed by a force, a distance between the at least one second electrode corresponding to a force sensing position and the part of the at least one first electrode is changed to sense a capacitance variation between the at least one first electrode and the at least one second electrode.

In an embodiment, touch sensing and force sensing are performed at the same time, but the force sensing position loses a touch sensing function.

In an embodiment, the at least one first electrode disposed on the first plane is driven as a touch sensing electrode by a touch signal, but the a part of the at least one first electrode corresponding to a force sensing position receives a ground level, a floating level or a reference voltage and the at least one second electrode corresponding to the force sensing position receives the touch signal; when the capacitive force sensing touch panel is pressed by a force, a distance between the at least one second electrode corresponding to the force sensing position and the part of the at least one first electrode is changed to sense a capacitance variation between the at least one first electrode and the at least one second electrode.

In an embodiment, touch sensing and force sensing are performed at the same time, and the force sensing position still has a touch sensing function.

In an embodiment, the at least one first electrode disposed on the first plane corresponds to a force sensing position and receives a ground level, a floating level or a reference voltage, the at least one second electrode disposed on the second plane is driven as a touch sensing electrode by a touch signal; when the capacitive force sensing touch panel is pressed by a force, a distance between the at least one first electrode corresponding to the force sensing position and the at least one second electrode is changed to sense a capacitance variation between the at least one first electrode and the at least one second electrode.

In an embodiment, touch sensing and force sensing are performed at the same time, and the force sensing position still has a touch sensing function.

In an embodiment, touch sensing and force sensing are performed in a time-sharing way, during a touch sensing period, the at least one first electrode disposed on the first plane corresponds to a force sensing position and receives a ground level, a floating level, a reference voltage or a touch signal, the at least one second electrode disposed on the second plane corresponds to the force sensing position and the at least one second electrode is driven as a touch sensing electrode by a touch signal; during a force sensing period, the at least one first electrode disposed on the first plane corresponds to the force sensing position and receives the reference voltage or a force sensing signal, the at least one second electrode disposed on the second plane corresponds to the force sensing position receives the ground level.

In an embodiment, the capacitive force sensing touch panel has an out-cell touch panel structure, the laminated structure further includes a liquid crystal module and a cover lens, and the first plane and the second plane are disposed between the liquid crystal module and the cover lens.

In an embodiment, the laminated structure further includes a first substrate and a second substrate, the first substrate is disposed on an upper surface of the liquid crystal module and the second substrate is disposed on a lower surface of the cover lens, the first plane and the second plane are located at an upper surface of the first substrate and a lower surface of the second substrate respectively.

In an embodiment, the laminated structure further includes a first substrate disposed on an upper surface of the liquid crystal module, and the first plane and the second plane are located at an upper surface of the first substrate and a lower surface of the cover lens respectively.

In an embodiment, the laminated structure further includes a first substrate disposed between the liquid crystal module and the cover lens, and the first plane and the second plane are located at a lower surface and an upper surface of the first substrate respectively.

In an embodiment, the capacitive force sensing touch panel has an on-cell touch panel structure, the laminated structure further includes a liquid crystal module and a cover lens, and the first plane and the second plane are disposed between the liquid crystal module and the cover lens.

In an embodiment, the laminated structure further includes a first substrate disposed on a lower surface of the cover lens, and the first plane and the second plane are located at an upper surface of the liquid crystal module and a lower surface of the first substrate respectively.

In an embodiment, the first plane and the second plane are located at an upper surface of the liquid crystal module and a lower surface of the cover lens respectively.

In an embodiment, the capacitive force sensing touch panel has an in-cell touch panel structure, the laminated structure further includes a first transparent layer and a second transparent layer, and the second transparent layer is disposed above the first transparent layer.

In an embodiment, the first plane and the second plane are located at an upper surface of the first transparent layer and a lower surface of the second transparent layer respectively.

In an embodiment, the first plane and the second plane are located at an upper surface of the first transparent layer and an upper surface of the second transparent layer respectively.

In an embodiment, the first plane and the second plane are located at an upper surface and a lower surface of the second transparent layer respectively.

In an embodiment, the laminated structure further includes a polarizer disposed on an upper surface of the second transparent layer, and the first plane and the second plane are located at a lower surface of the second transparent layer and an upper surface of the polarizer respectively.

In an embodiment, the laminated structure further includes a polarizer and a cover lens, the polarizer is disposed on an upper surface of the second transparent layer and the cover lens is disposed above the polarizer, and the first plane and the second plane are located at a lower surface of the second transparent layer and a lower surface of the cover lens respectively.

In an embodiment, a touch and force sensing mode of the capacitive force sensing touch panel and a display mode of the capacitive force sensing touch panel are driven in a time-sharing way, and the capacitive force sensing touch panel is operated in the touch and force sensing mode during a blanking interval of a display period and operated in the display mode during a display interval of the display period.

In an embodiment, the blanking interval includes at least one of a vertical blanking interval (VBI), a horizontal blanking interval (HBI), and a long horizontal blanking interval (LHBI); a time length of the LHBI is equal to or larger than a time length of the HBI; the LHBI is obtained by redistributing a plurality of HBIs or the LHBI includes the VBI.

In an embodiment, a force sensing mode of the capacitive force sensing touch panel and a display mode of the capacitive force sensing touch panel are driven in a time-sharing way, and the capacitive force sensing touch panel is operated in the force sensing mode during a blanking interval of a display period and operated in the display mode and a touch sensing mode at the same time during a display interval of the display period.

In an embodiment, when the first conductive layer and the second conductive layer are driven as the touch sensing electrode, the first conductive layer and the second conductive layer include at least one driving electrode and at least one sensing electrode respectively to receive a driving signal and a sensing signal respectively.

In an embodiment, when the first conductive layer and the second conductive layer are driven as the force sensing electrode, the first conductive layer includes at least one driving electrode and receives a force sensing signal, a driving signal or a reference voltage, and the second conductive layer includes at least one sensing electrode and receives a ground level or a floating level.

In an embodiment, when the first conductive layer and the second conductive layer are driven as the touch sensing electrode, the first conductive layer includes at least one driving electrode and receives a driving signal, and the second conductive layer includes at least one sensing electrode and at least one dummy electrode interlaced to receive a sensing signal and a floating level respectively.

In an embodiment, when the first conductive layer and the second conductive layer are driven as the force sensing electrode, the first conductive layer includes at least one driving electrode and receives a force sensing signal, a driving signal or a reference voltage, and the second conductive layer includes at least one sensing electrode and at least one dummy electrode interlaced to receive a ground level or a floating level at the same time.

In an embodiment, the at least one first electrode disposed on the first plane includes a first direction first electrode and a second direction first electrode to form a self-capacitive structure or a mutual-capacitive structure; the at least one second electrode disposed on the second plane includes a first direction second electrode and a second direction second electrode to form a mutual-capacitive structure.

In an embodiment, a pitch between the at least one first electrode disposed on the first plane is larger than or equal to a pitch between the at least one second electrode disposed on the second plane.

In an embodiment, when the capacitive force sensing touch panel is operated in a touch sensing mode, the first direction second electrode and the second direction second electrode receive a touch driving signal and a touch sensing signal respectively to perform mutual-capacitive sensing, and the first direction first electrode and the second direction first electrode receive a floating level, a ground level or a fixed level.

In an embodiment, when the capacitive force sensing touch panel is operated in a force sensing mode, the first direction second electrode and the second direction second electrode receive a fixed reference voltage or a ground level to be a shielding electrode, and the first direction first electrode and the second direction first electrode receive the same force sensing voltage to sense a self-capacitance variation, or the first direction first electrode and the second direction first electrode receive different force sensing voltages respectively to sense a mutual-capacitance variation.

Compared to the prior arts, the capacitive force sensing touch panel of the invention has the following advantages and effects:

(1) Although the touch sensing and the force sensing are both determined according to the capacitance variation, in the invention, a relative upper electrode is used or the electrodes are divided into touch sensing electrodes and force sensing electrodes according to different functions during the force sensing period to avoid the effects caused by the change of the finger pressing area to maintain the accurate sensed capacitance.

(2) The capacitive force sensing touch panel of the invention can be applied to different touch panel structures such as in-cell touch panel structure, on-cell touch panel structure or out-cell touch panel structure.

(3) A force sensing electrode can be disposed between the touch sensing electrode and the liquid crystal module to shield the noise of the liquid crystal module and effectively increase the signal-to-noise ratio of touch sensing.

(4) Touch sensing and force sensing of the capacitive force sensing touch panel can be driven in a time-sharing way and operated during the blanking interval of the display period to avoid the noise interference of the liquid crystal module.

(5) The touch electrodes can be used for touch sensing and force sensing respectively by switching the touch electrode signal without additionally disposing any force sensing electrodes.

(6) The number of channels required can be reduced by two mutual-capacitive electrode layers and since no trace is routed in the active area of the touch panel, the dead zone without any touch function can be avoided; therefore, it can be applied to the middle-size or large-size touch panel.

The advantage and spirit of the invention may be understood by the following detailed descriptions together with the appended drawings.

### BRIEF DESCRIPTION OF THE APPENDED DRAWINGS

FIG. 1 illustrates a schematic diagram of the sensing electrode and the reference electrode in the laminated structure of the conventional capacitive touch panel.

FIG. 2A˜FIG. 2C illustrate top views and cross-sectional schematic diagrams of the laminated structure of the capacitive force sensing touch panel in an embodiment of the invention.

FIG. 3A˜FIG. 3C illustrate top views and cross-sectional schematic diagrams of the laminated structure of the capacitive force sensing touch panel in an embodiment of the invention.

FIG. 4A˜FIG. 4C illustrate top views and cross-sectional schematic diagrams of the laminated structure of the capacitive force sensing touch panel in an embodiment of the invention.

FIG. 5A˜FIG. 5C illustrate top views and cross-sectional schematic diagrams of the laminated structure of the capacitive force sensing touch panel in an embodiment of the invention.

FIG. 6A˜FIG. 6C illustrate cross-sectional schematic diagrams of different out-cell laminated structures of the capacitive force sensing touch panel of the invention.

FIG. 7A˜FIG. 7B illustrate cross-sectional schematic diagrams of different on-cell laminated structures of the capacitive force sensing touch panel of the invention.

FIG. 8A˜FIG. 8E illustrate cross-sectional schematic diagrams of different in-cell laminated structures of the capacitive force sensing touch panel of the invention.

FIG. 9A˜FIG. 9C illustrate top views and cross-sectional schematic diagrams of the laminated structure of the capacitive force sensing touch panel in an embodiment of the invention.

FIG. 10A˜FIG. 10C illustrate top views and cross-sectional schematic diagrams of the laminated structure of the capacitive force sensing touch panel in an embodiment of the invention.

FIG. 11A˜FIG. 11C illustrate top views and cross-sectional schematic diagrams of the laminated structure of the capacitive force sensing touch panel in an embodiment of the invention.

FIG. 12 illustrates schematic diagrams of the vertical blanking interval (VBI), the horizontal blanking interval (HBI) and the long horizontal blanking interval (LHBI).

FIG. 13A illustrates a timing diagram of the capacitive force sensing touch panel performing force sensing during the blanking interval of the display period.

FIG. 13B illustrates a timing diagram of the capacitive force sensing touch panel performing both force sensing and touch sensing during the blanking interval of the display period.

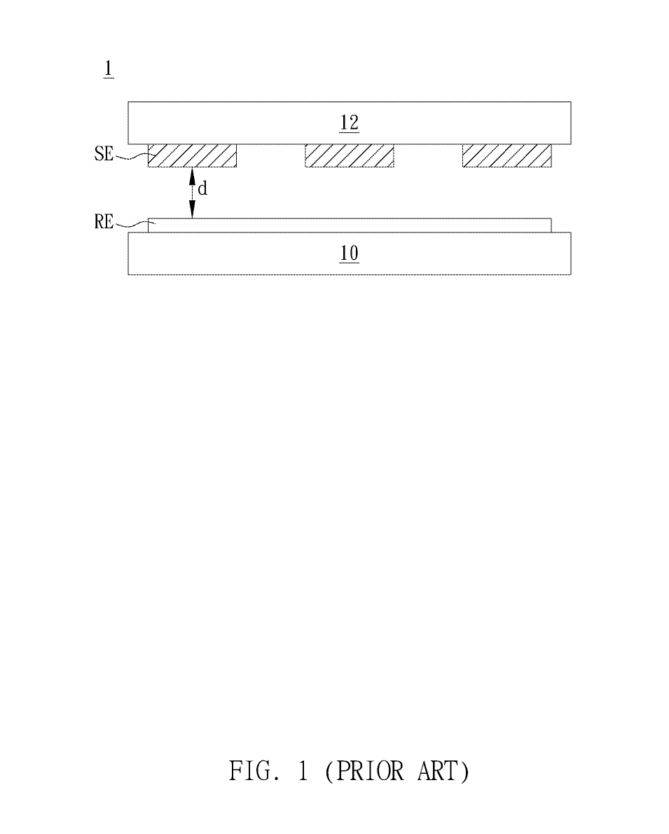

### DETAILED DESCRIPTION OF THE INVENTION

An embodiment of the invention is a capacitive force sensing touch panel. In this embodiment, the capacitive force sensing touch panel can have different touch panel structures such as an in-cell touch panel structure, an on-cell touch panel structure or an out-cell touch panel structure. In this invention, a relative upper electrode can be used or the electrodes can be divided into touch sensing electrodes and force sensing electrodes according to different functions during the force sensing period to avoid the effects caused by the change of the finger pressing area to maintain the accurate sensed capacitance. Therefore, the problems of the prior arts can be solved.

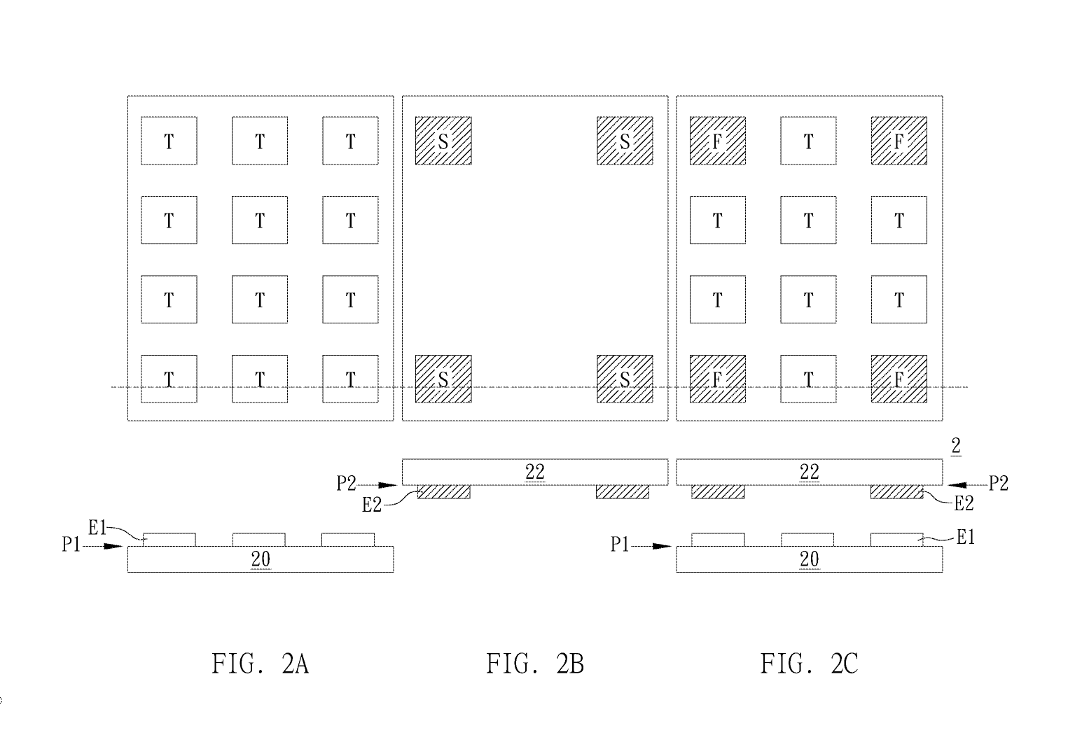

At first, please refer to FIG. 2A˜FIG. 2C. In this embodiment, the capacitive force sensing touch panel includes a plurality of pixels. A laminated structure 2 of each pixel includes a first substrate 20, a second substrate 22, a plurality of first electrodes E1 and a plurality of second electrodes E2. Wherein, the plurality of first electrodes E1 is disposed on the first surface P1 at intervals and the first surface P1 is an upper surface of the first substrate 20; the plurality of second electrodes E2 is disposed on the second surface P2 at intervals and the second surface P2 is a lower surface of the second substrate 22.

In detail, the plurality of first electrodes E1 disposed on the first surface P1 is arranged in a matrix form and they receive touch signals and driven as touch electrodes T respectively. These touch electrodes T can be self-capacitive touch electrodes or mutual-capacitive touch electrodes. The plurality of second electrodes E2 disposed on the second surface P2 can receive a ground level or a floating level. They are disposed on four force sensing positions respectively and correspond to four first electrodes E1 which are also disposed on four force sensing positions respectively. The plurality of second electrodes E2 disposed above can be used as shielding electrodes of the four first electrodes E1 respectively. When the capacitive force sensing touch panel is pressed by a force, a distance between the second electrodes E2 corresponding to the force sensing positions and the first electrodes E1 will be changed to sense a capacitance variation between the first electrodes E1 and the second electrodes E2. Since the second electrodes E2 can shield the first electrodes E1, the effects caused by the change of the finger pressing area during the force sensing period can be avoided to maintain the accurate sensed capacitance data.

It should be noticed that the four first electrodes E1 disposed at four corner positions during the force sensing period in this embodiment will lose the touch sensing function and fail to perform touch sensing at the same time.

In practical applications, as to touch sensing, if only the at least one first electrode E1 disposed on the first plane P1 or the at least one second electrode E2 disposed on the second plane P2 is driven as a touch sensing electrode, it is the self-capacitive touch sensing structure formed accordingly; if both the at least one first electrode E1 disposed on the first plane P1 and the at least one second electrode E2 disposed on the second plane P2 are driven as touch sensing electrodes, it is the mutual-capacitive touch sensing structure formed accordingly. As to force sensing, it is possible that only the at least one first electrode E1 disposed on the first plane P1 or the at least one second electrode E2 disposed on the second plane P2 is driven as a force sensing electrode, or both the at least one first electrode E1 disposed on the first plane P1 and the at least one second electrode E2 disposed on the second plane P2 are driven as force sensing electrodes.

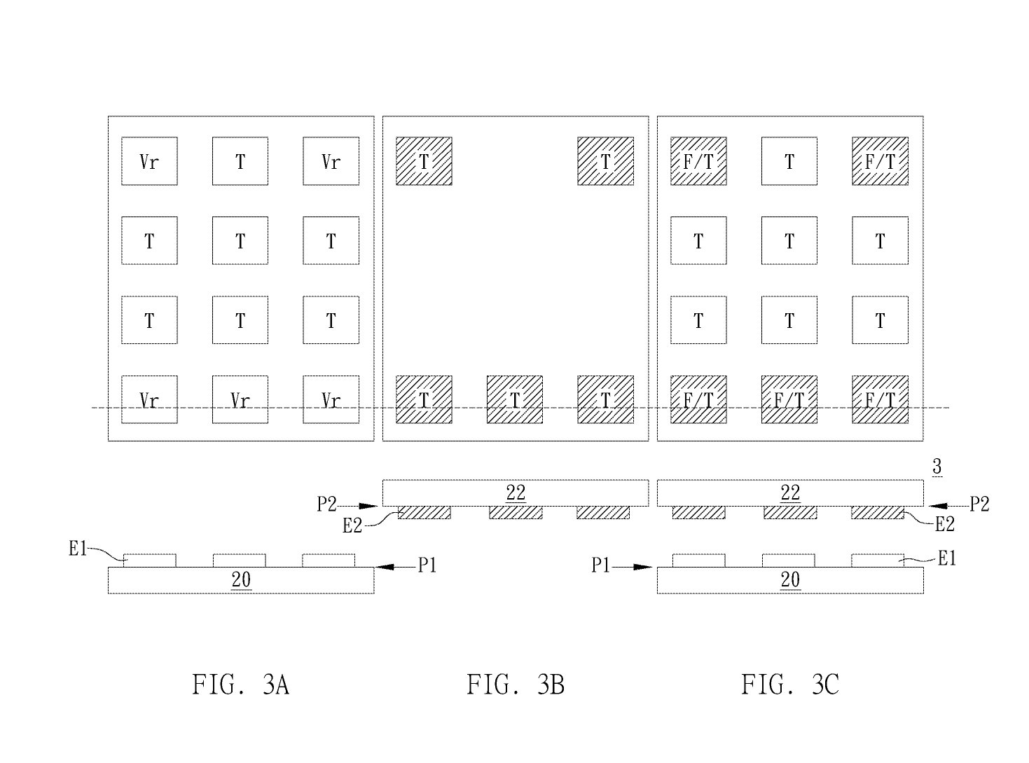

In another embodiment, as shown in FIG. 3A˜FIG. 3C, the laminated structure 3 of the capacitive force sensing touch panel includes a first substrate 20, a second substrate 22, a plurality of first electrodes E1 and a plurality of second electrodes E2. Wherein, the plurality of first electrodes E1 is disposed on the first surface P1 at intervals and the first surface P1 is the upper surface of the first substrate 20; the plurality of second electrodes E2 is disposed on the second surface P2 at intervals and the second surface P2 is the lower surface of the second substrate 22.

In detail, the plurality of first electrodes E1 disposed on the first surface P1 is arranged as a matrix, wherein if there is a second electrode E2 disposed above the corresponding first electrode E1, then the first electrode E1 will receive a voltage signal Vr which can be a ground level, a floating level or a reference voltage; if there is no second electrode E2 disposed above the corresponding first electrode E1, then the first electrode E1 will receive a touch signal and used as a touch electrode T; the second electrodes E2 disposed on the second surface P2 will receive touch signals and used as touch electrodes T which are disposed at five force sensing positions respectively and corresponding to lower five first electrodes E1 disposed at the same five force sensing positions, so that the second electrodes E2 can shield the first electrodes E1, and the effects caused by the change of the finger pressing area during the force sensing period can be avoided to maintain the accurate sensed capacitance data. It should be noticed that the five force sensing positions performing force sensing in this embodiment can still have the touch sensing function; therefore, the touch sensing and the force sensing can be performed at the same time, as shown by F/T in FIG. 3C.

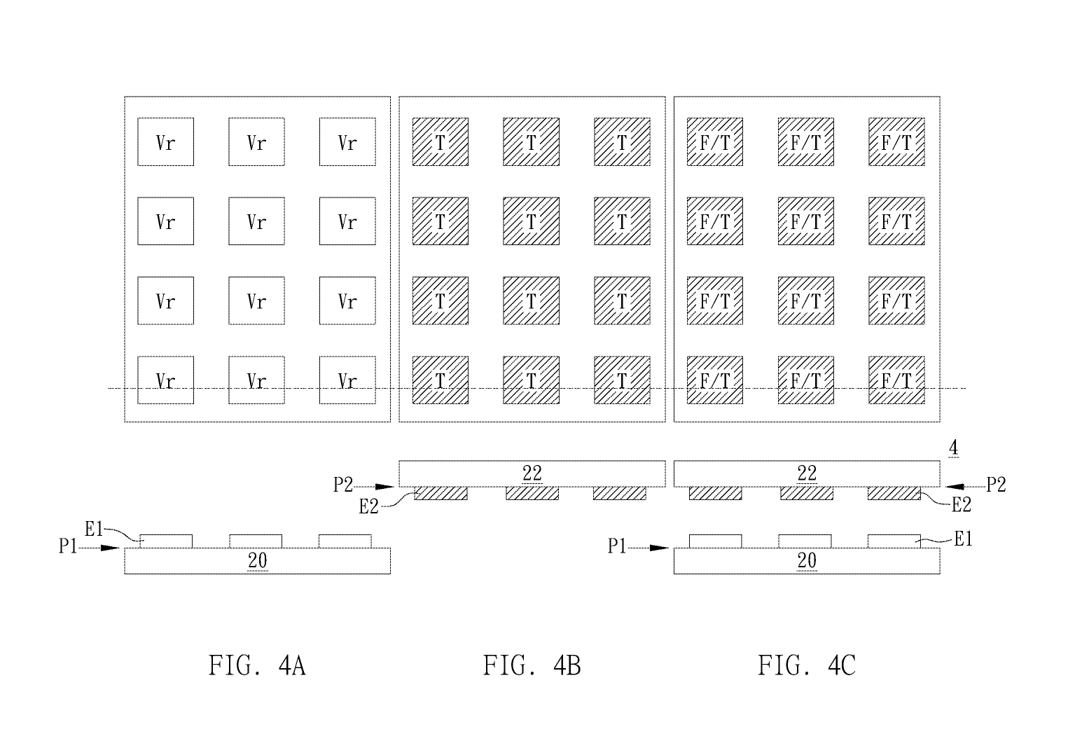

In another embodiment, as shown in FIG. 4A˜FIG. 4C, the laminated structure 4 of the capacitive force sensing touch panel includes a first substrate 20, a second substrate 22, a plurality of first electrodes E1 and a plurality of second electrodes E2. Wherein, the plurality of first electrodes E1 is disposed on the first surface P1 at intervals and the first surface P1 is the upper surface of the first substrate 20; the plurality of second electrodes E2 is disposed on the second surface P2 at intervals and the second surface P2 is the lower surface of the second substrate 22. The plurality of first electrodes E1 disposed on the first surface P1 and the plurality of second electrodes E2 disposed on the second surface P2 are arranged as matrixes corresponding to each other up and down, so that the second electrodes E2 can shield the first electrodes E1, and the effects caused by the change of the finger pressing area during the force sensing period can be avoided to maintain the accurate sensed capacitance data.

The plurality of first electrodes E1 receives a voltage signal Vr which can be a ground level, a floating level or a reference voltage; the plurality of second electrodes E2 receives a touch signal and used as touch electrodes T. It should be noticed that all force sensing positions performing force sensing in this embodiment can still have the touch sensing function; therefore, the touch sensing and the force sensing can be performed at the same time, as shown by F/T in FIG. 4C.

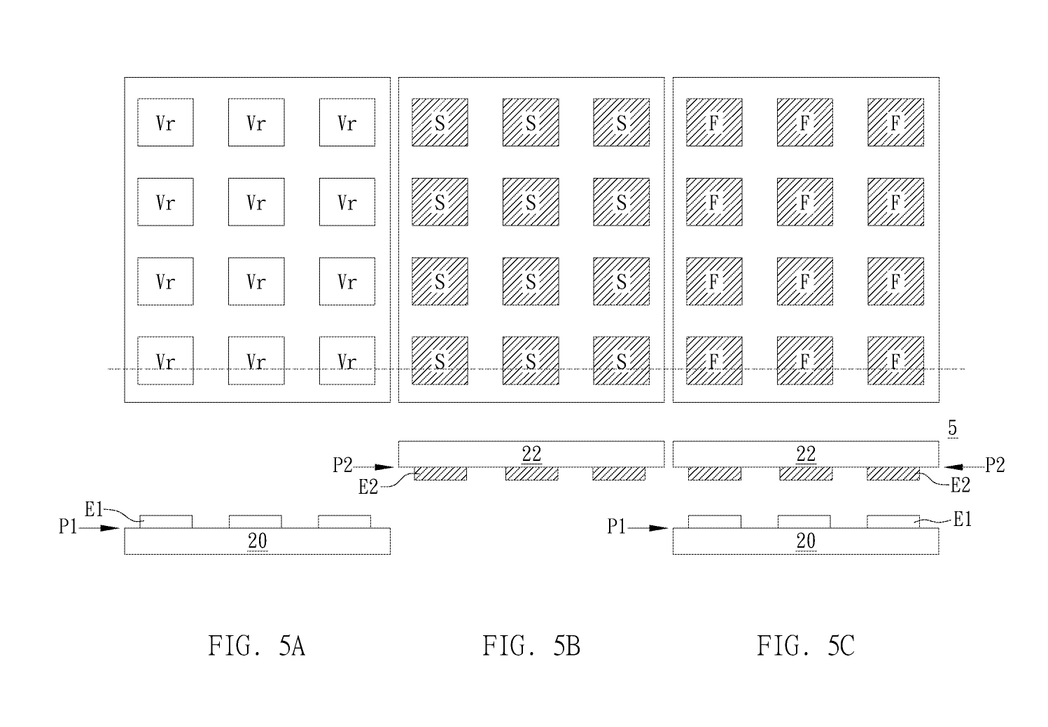

The touch sensing and the force sensing can be not only driven at the same time as shown in the above-mentioned embodiments, but also driven in a time-sharing way. Please refer to FIG. 5A˜FIG. 5C. As shown in FIG. 5A˜FIG. 5C, the plurality of first electrodes E1 disposed on the first surface P1 and the plurality of second electrodes E2 disposed on the second surface P2 are arranged as matrixes corresponding to each other up and down, so that the second electrodes E2 can shield the first electrodes E1, and the effects caused by the change of the finger pressing area during the force sensing period can be avoided to maintain the accurate sensed capacitance data.

During the touch sensing period, the plurality of first electrodes E1 disposed on the first surface P1 receives the voltage signal Vr which can be a ground level, a floating level, a reference voltage or a touch signal, and the plurality of second electrodes E2 disposed on the second surface P2 corresponds to the plurality of first electrodes E1 and receives the touch signal; during the force sensing period, the plurality of first electrodes E1 disposed on the first surface P1 receives the voltage signal Vr which can be a reference voltage or a touch signal, and the plurality of second electrodes E2 disposed on the second surface P2 receives the voltage signal S which can be a ground level or a reference voltage, but not limited to this.

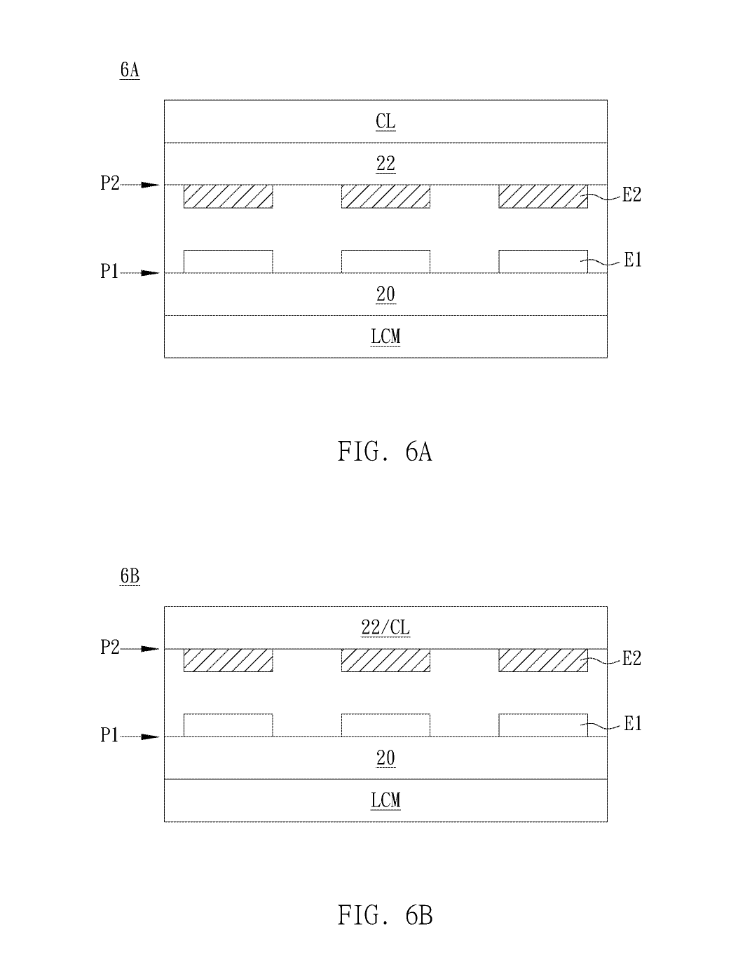

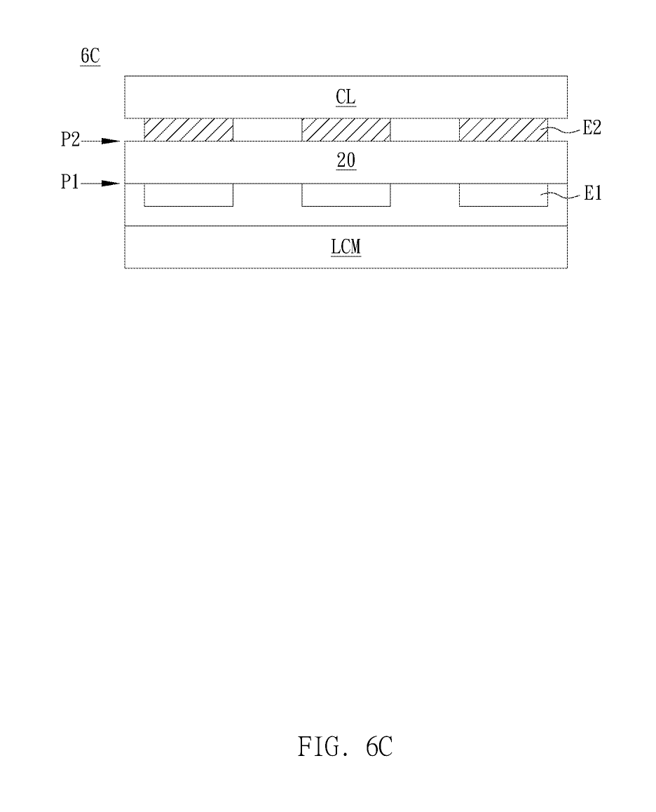

Please refer to FIG. 6A˜FIG. 6C. FIG. 6A˜FIG. 6C illustrate cross-sectional schematic diagrams of different out-cell laminated structures of the capacitive force sensing touch panel of the invention.

As shown in FIG. 6A, in the laminated structure 6A, the first substrate 20 is disposed above the liquid crystal module LCM; the plurality of first electrodes E1 is disposed on the first surface P1 at intervals and the first surface P1 is an upper surface of the first substrate 20; the plurality of second electrodes E2 is disposed on the second surface P2 at intervals and the second surface P2 is a lower surface of the second substrate 22; the cover lens CL is disposed above the second substrate 22. The difference between the illuminated structure 6B of FIG. 6B and the illuminated structure 6A of FIG. 6A is that the cover lens CL and the second substrate 22 in the illuminated structure 6B are integrated in the same layer, so that the thickness of the entire illuminated structure 6B can be reduced accordingly.

In the illuminated structure 6C of FIG. 6C, the plurality of first electrodes E1 is disposed on the first surface P1 at intervals and the plurality of second electrodes E2 is disposed on the second surface P2 at intervals. The difference between the illuminated structure 6C of FIG. 6C and the illuminated structures 6A-6B of FIG. 6A˜FIG. 6B is that the first surface P1 and the second surface P2 in the illuminated structure 6C are the lower surface and the upper surface of the same substrate (namely the first substrate 20) respectively.

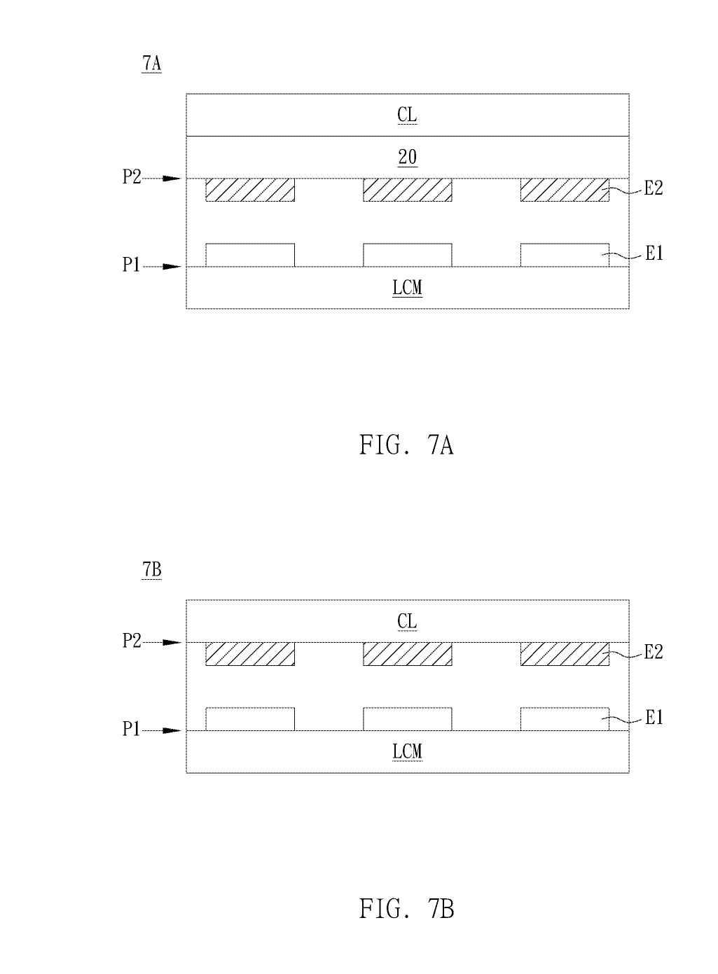

Please refer to FIG. 7A˜FIG. 7B. FIG. 7A˜FIG. 7B illustrate cross-sectional schematic diagrams of different on-cell laminated structures of the capacitive force sensing touch panel of the invention.

As shown in FIG. 7A, in the laminated structure 7A, the plurality of first electrodes E1 is disposed on the first surface P1 at intervals and the first surface P1 is an upper surface of the liquid crystal module LCM; the plurality of second electrodes E2 is disposed on the second surface P2 at intervals and the second surface P2 is a lower surface of the first substrate 20; the cover lens CL is disposed above the first substrate 20. The difference between the illuminated structure 7B of FIG. 7B and the illuminated structure 7A of FIG. 7A is that there is no first substrate 20 in the illuminated structure 7B, namely the plurality of second electrodes E2 is disposed on the second surface P2 at intervals and the second surface P2 is a lower surface of the cover lens CL, so that the thickness of the entire illuminated structure 7B can be reduced accordingly.

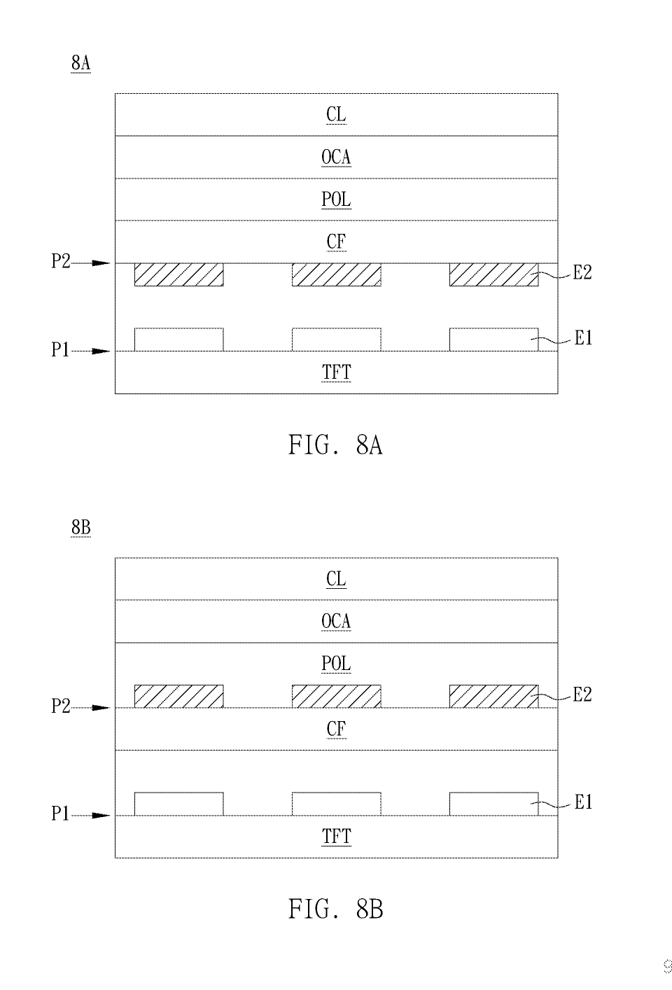

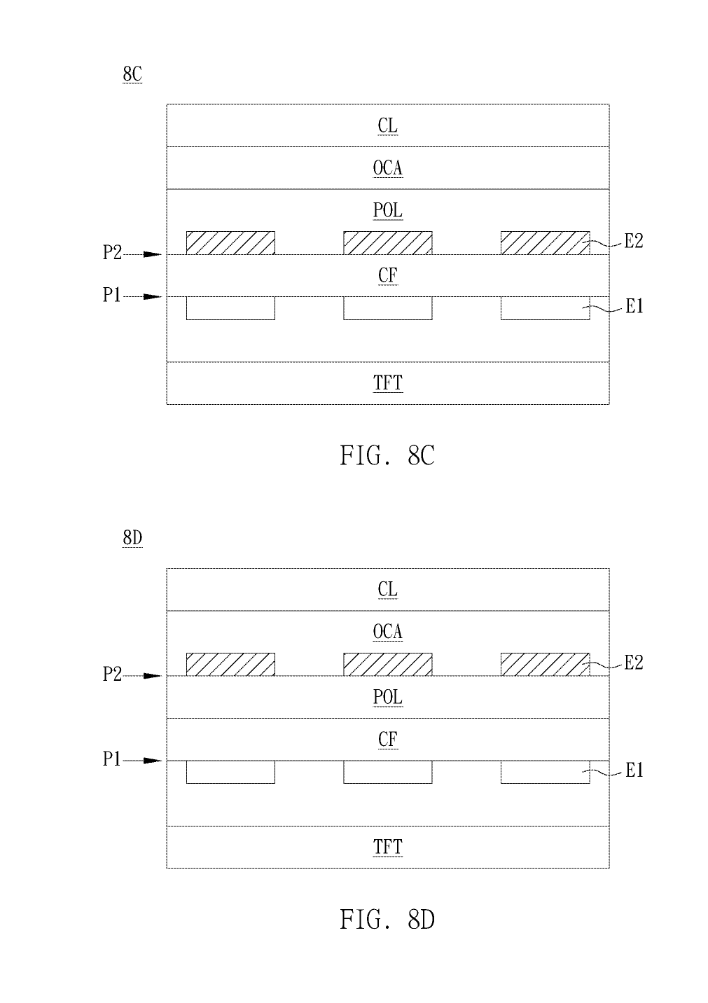

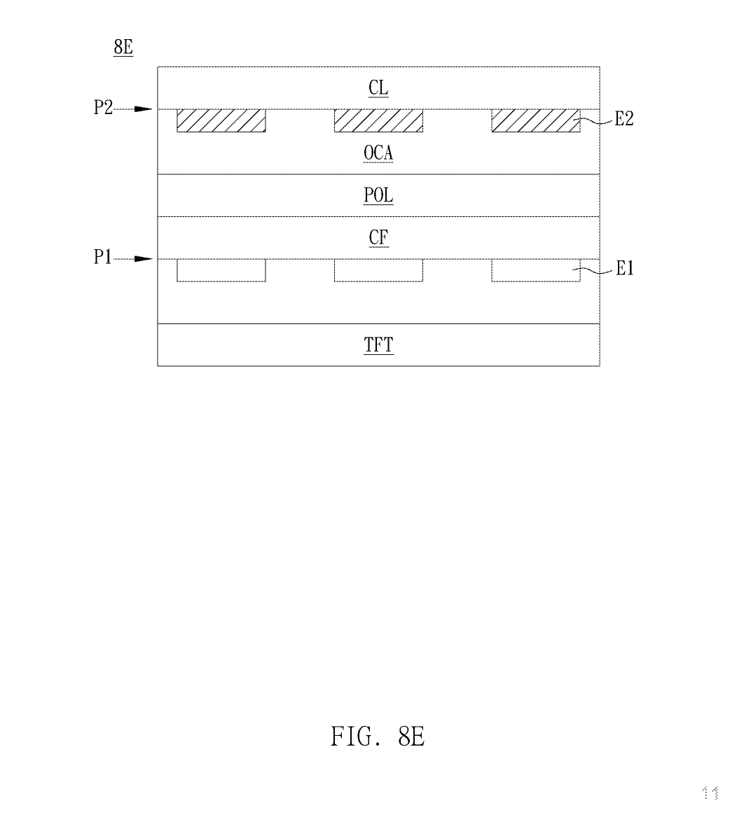

Please refer to FIG. 8A˜FIG. 8E. FIG. 8A˜FIG. 8E illustrate cross-sectional schematic diagrams of different in-cell laminated structures of the capacitive force sensing touch panel of the invention.

As shown in FIG. 8A, in the laminated structure 8A, the second transparent layer (e.g., the color filter glass layer) CF is disposed above the first transparent layer (e.g., the TFT glass layer) TFT; the plurality of first electrodes E1 is disposed on the first surface P1 at intervals and the first surface P1 is an upper surface of the first transparent layer (e.g., the TFT glass layer) TFT; the plurality of second electrodes E2 is disposed on the second surface P2 at intervals and the second surface P2 is a lower surface of the second transparent layer (e.g., the color filter glass layer) CF; the polarizer POL, the optical clear adhesive OCA and the cover lens CL are disposed above the second transparent layer (e.g., the color filter glass layer) CF in order.

The difference between the illuminated structure 8B of FIG. 8B and the illuminated structure 8A of FIG. 8A is that the second surface P2 which the plurality of second electrodes E2 is disposed on at intervals in the illuminated structure 8B is the upper surface of the second transparent layer (e.g., the color filter glass layer) CF instead of the lower surface of the second transparent layer (e.g., the color filter glass layer) CF.

The difference between the illuminated structure 8C of FIG. 8C and the illuminated structures 8A-8B of FIG. 8A˜FIG. 8B is that the first surface P1 which the plurality of first electrodes E1 is disposed on at intervals and the second surface P2 which the plurality of second electrodes E2 is disposed on at intervals in the illuminated structure 8C are the lower surface and the upper surface of the second transparent layer (e.g., the color filter glass layer) CF respectively.

The difference between the illuminated structure 8D of FIG. 8D and the illuminated structures 8A˜8C of FIG. 8A˜FIG. 8C is that the first surface P1 which the plurality of first electrodes E1 is disposed on at intervals in the illuminated structure 8D is the lower surface of the second transparent layer (e.g., the color filter glass layer) CF and the second surface P2 which the plurality of second electrodes E2 is disposed on at intervals in the illuminated structure 8D is the upper surface of the polarizer POL.

The difference between the illuminated structure 8D of FIG. 8D and the illuminated structures 8A˜8C of FIG. 8A˜FIG. 8C is that the first surface P1 which the plurality of first electrodes E1 is disposed on at intervals in the illuminated structure 8D is the lower surface of the second transparent layer (e.g., the color filter glass layer) CF and the second surface P2 which the plurality of second electrodes E2 is disposed on at intervals in the illuminated structure 8D is the upper surface of the polarizer POL.

The difference between the illuminated structure 8E of FIG. 8E and the illuminated structures 8A˜8D of FIG. 8A˜FIG. 8D is that the first surface P1 which the plurality of first electrodes E1 is disposed on at intervals in the illuminated structure 8E is the lower surface of the color filter glass layer CF and the second surface P2 which the plurality of second electrodes E2 is disposed on at intervals in the illuminated structure 8D is the lower surface of the cover lens CL.

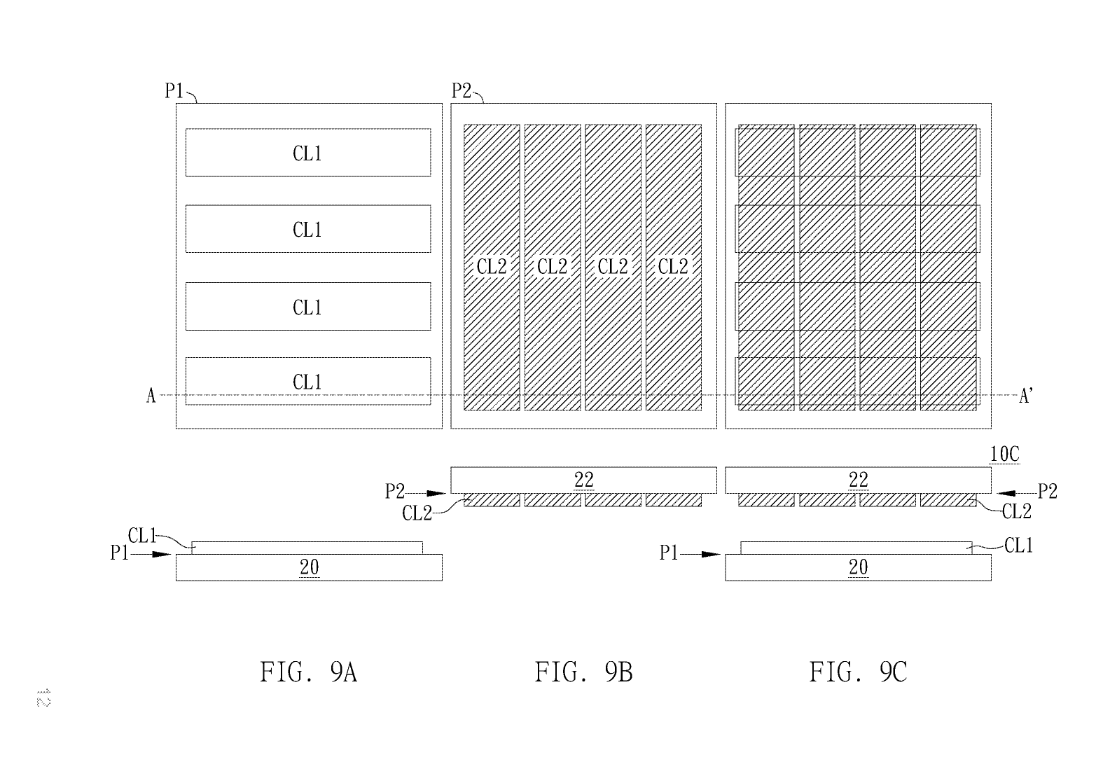

Then, please refer to FIG. 9A˜FIG. 9C. FIG. 9A˜FIG. 9C illustrate top views and cross-sectional schematic diagrams of the laminated structure of the capacitive force sensing touch panel in an embodiment of the invention. As shown in FIG. 9A˜FIG. 9C, in the laminated structure 10C of the capacitive force sensing touch panel, the plurality of first conductive layers CL1 is disposed on the first surface P1 at intervals along a first direction and the first surface P1 is an upper surface of the first substrate 20; the plurality of second conductive layers CL2 is disposed on the second surface P2 at intervals along a second direction and the second surface P2 is a lower surface of the second substrate 22.

It should be noticed that the plurality of first conductive layers CL1 and the plurality of second conductive layers CL2 can form a mutual-capacitive sensing structure, and the plurality of first conductive layers CL1 and the plurality of second conductive layers CL2 can be selectively driven as touch sensing electrodes or force sensing electrodes.

In an embodiment, when the plurality of first conductive layers CL1 and the plurality of second conductive layers CL2 are driven as touch sensing electrodes during the touch sensing period, the plurality of first conductive layers CL1 and the plurality of second conductive layers CL2 will be driven respectively and include at least one driving electrode (TX) and at least one sensing electrode (RX), and the at least one driving electrode (TX) and the at least one sensing electrode (RX) receive a driving signal and a sensing signal respectively to complete the mutual-capacitive touch sensing; when the plurality of first conductive layers CL1 and the plurality of second conductive layers CL2 are driven as force sensing electrodes, the plurality of first conductive layers CL1 will be driven and include at least one driving electrode (TX) receiving a force sensing signal, a driving signal or a reference voltage, and the plurality of second conductive layers CL2 will be driven and include at least one sensing electrode (RX) receiving a ground level or a floating level, but not limited to this.

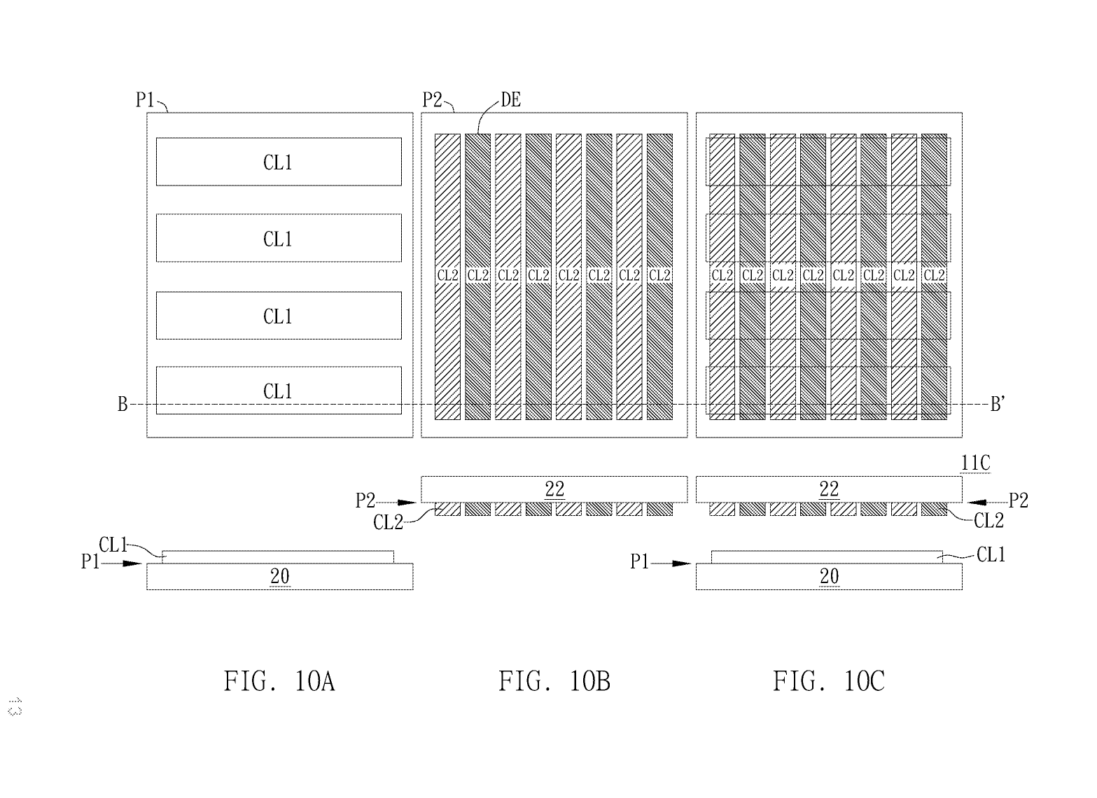

In another embodiment, as shown in FIG. 10A˜FIG. 10C, when the plurality of first conductive layers CL1 and the plurality of second conductive layers CL2 are driven as touch sensing electrodes during the touch sensing period, the plurality of first conductive layers CL1 will be driven and include at least one driving electrode (TX) receiving a driving signal, and the plurality of second conductive layers CL2 will be driven and include at least one sensing electrode (RX) and at least one dummy electrode (DE) disposed at intervals, wherein the at least one sensing electrode (RX) receives a sensing signal and the at least one dummy electrode (DE) receives a floating level; when the plurality of first conductive layers CL1 and the plurality of second conductive layers CL2 are driven as force sensing electrodes during the force sensing period, the plurality of first conductive layers CL1 will be driven and include at least one driving electrode (TX) receiving a force sensing signal, a driving signal or a reference voltage, and the plurality of second conductive layers CL2 will be driven and include at least one sensing electrode (RX) and at least one dummy electrode (DE) disposed at intervals, and the at least one sensing electrode (RX) and the at least one dummy electrode (DE) can receive a ground level or a floating level at the same time, but not limited to this.

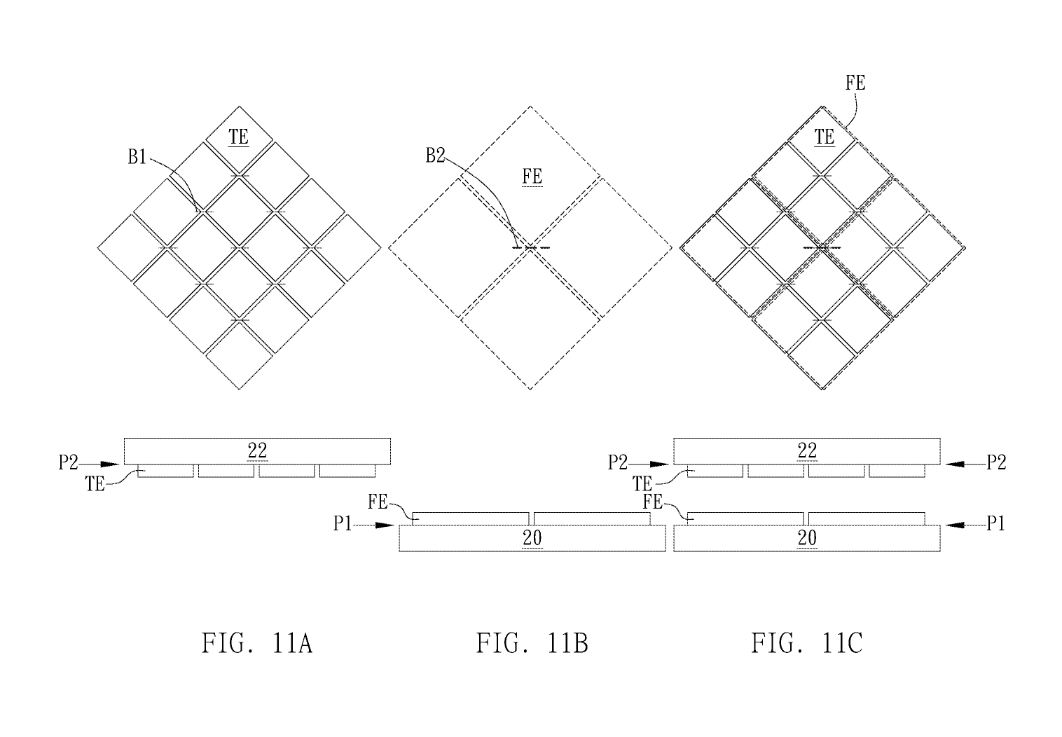

Then, please refer to FIG. 11A˜FIG. 11C. FIG. 11A˜FIG. 11C illustrate top views and cross-sectional schematic diagrams of the laminated structure of the capacitive force sensing touch panel in an embodiment of the invention.

As shown in FIG. 11A˜FIG. 11C, a plurality of second electrodes disposed on the second surface P2 (namely the lower surface of the second substrate 22) includes X-direction second electrodes arranging along X-direction and Y-direction second electrodes arranging along Y-direction forming mutual-capacitive structure and driven as touch sensing electrodes TE to perform mutual-capacitive touch sensing; a plurality of first electrodes disposed on the first surface P1 (namely the upper surface of the first substrate 20) includes X-direction first electrodes arranging along X-direction and Y-direction first electrodes arranging along Y-direction forming mutual-capacitive structure and driven as force sensing electrodes FE to perform self-capacitive or mutual-capacitive touch sensing. Wherein, B1 and B2 are bridge structures of the touch sensing electrodes TE and the force sensing electrodes FE respectively.

In this embodiment, the touch sensing electrodes TE of the capacitive force sensing touch panel is disposed above the force sensing electrodes FE, but not limited to this. When the capacitive force sensing touch panel is pressed by a force, a distance between the touch sensing electrodes TE and the force sensing electrodes FE will be changed, so that a capacitance variation between the touch sensing electrodes TE and the force sensing electrodes FE can be sensed accordingly.

When the capacitive force sensing touch panel is operated in the touch sensing mode, the X-direction second electrode and the Y-direction second electrode driven as touch sensing electrodes TE will receive the touch driving signal (TX) and the touch sensing signal (RX) respectively to perform mutual-capacitive touch sensing, and the X-direction first electrode and the Y-direction first electrode receive a floating level, a ground level or a fixed level at this time. When the capacitive force sensing touch panel is operated in the force sensing mode, the X-direction second electrode and the Y-direction second electrode receive a fixed reference level or a ground level as a shielding electrode. The X-direction first electrode and the Y-direction first electrode driven as force sensing electrodes FE can receive the same force sensing voltage to sense the self-capacitance variation, or the X-direction first electrode and the Y-direction first electrode can also receive different force sensing voltages to sense the mutual-capacitance variation.

It should be noticed that, no matter along X-direction or Y-direction, the pitch between the force sensing electrodes FE disposed on the upper surface of the first substrate 20 will be larger than or equal to the pitch between the touch sensing electrodes TE disposed on the lower surface of the second substrate 22. In this embodiment, the pitch between the force sensing electrodes FE disposed on the upper surface of the first substrate 20 is twice of the pitch between the touch sensing electrodes TE disposed on the lower surface of the second substrate 22, but not limited to this.

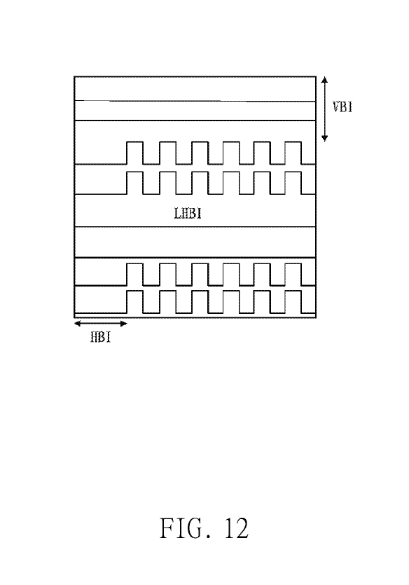

Please refer to FIG. 12. FIG. 12 illustrates schematic diagrams of the vertical blanking interval (VBI), the horizontal blanking interval (HBI) and the long horizontal blanking interval (LHBI). In practical applications, the capacitive force sensing touch panel can use different blanking intervals based on different driving ways. As shown in FIG. 12, the blanking interval includes at least one of a vertical blanking interval (VBI), a horizontal blanking interval (HBI), and a long horizontal blanking interval (LHBI); a time length of the LHBI is equal to or larger than a time length of the HBI; the LHBI is obtained by redistributing a plurality of HBIs or the LHBI includes the VBI.

It should be noticed that the capacitive force sensing touch panel of the invention can be operated in the display mode and the touch mode respectively at different times. That is to say, the touch mode and the display mode of the capacitive force sensing touch panel of the invention can be driven in a time-sharing way. For example, the capacitive force sensing touch panel of the invention can be operated in the touch mode during the non-display timing (namely the blanking interval of the image signal) to perform touch sensing, but not limited to this.

In addition, the capacitive force sensing touch panel of the invention can be operated in the display mode and the force mode respectively at different times. That is to say, the force sensing mode and the display mode of the capacitive force sensing touch panel of the invention can be driven in a time-sharing way. For example, the capacitive force sensing touch panel of the invention can be operated in the force sensing mode during the blanking interval of the display period and it can be also operated in the display mode and the touch mode at the same time during the display interval of the display period. That is to say, the force sensing period of the capacitive force sensing touch panel will overlap the blanking interval of the display period instead of overlapping the display interval of the display period, but not limited to this.

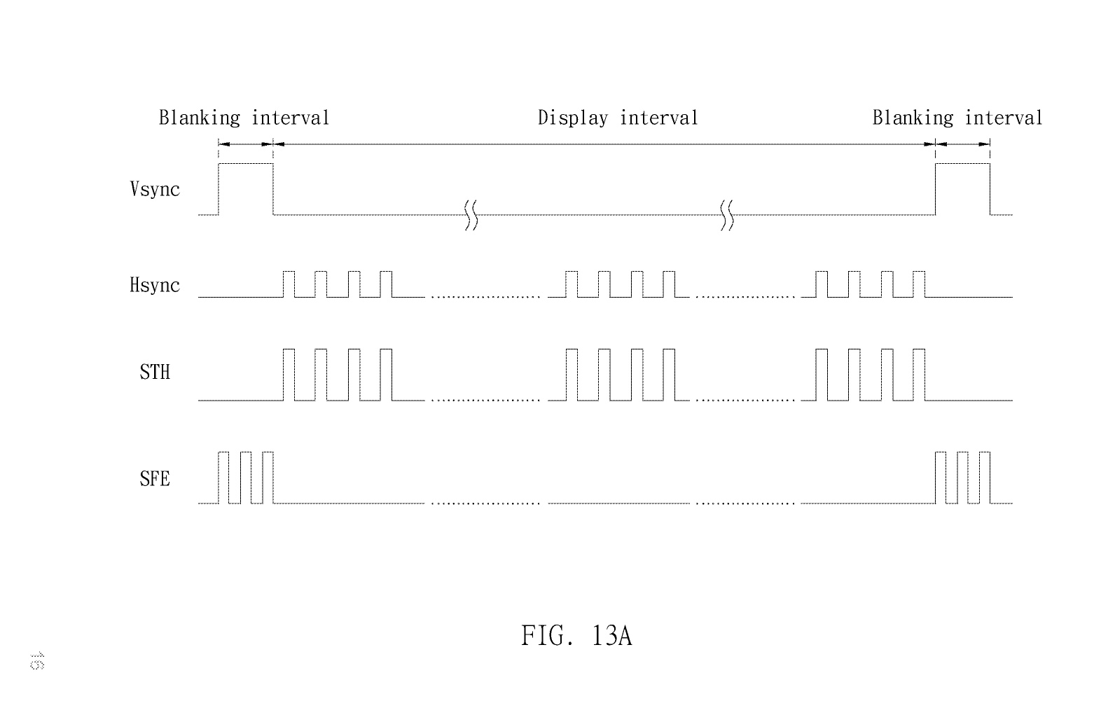

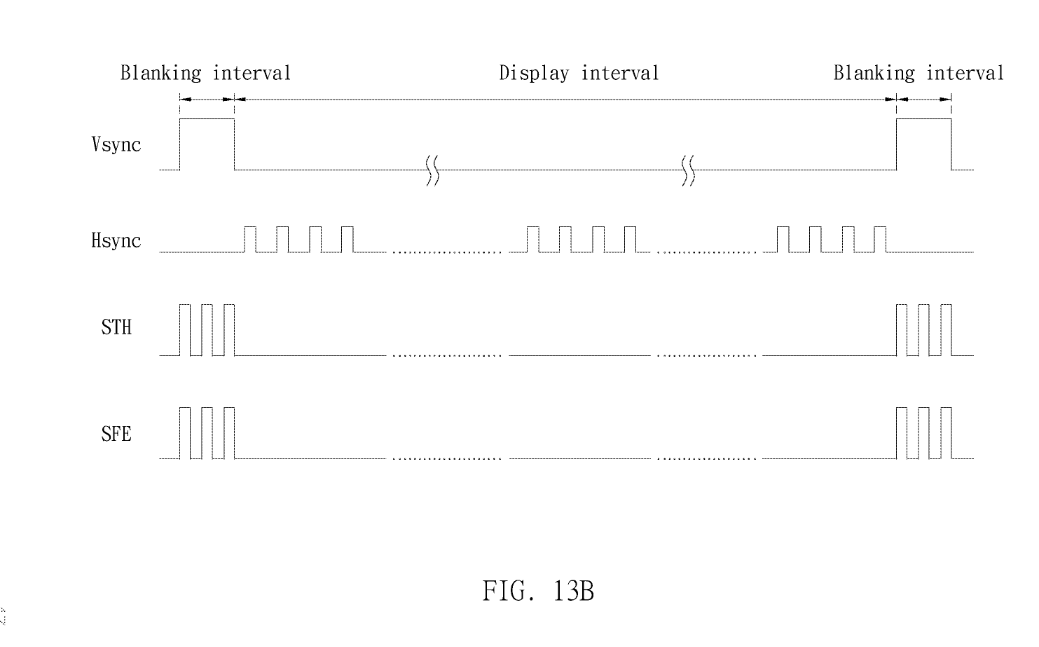

Above all, the touch sensing and the force sensing of the capacitive force sensing touch panel of the invention can be operated in the blanking interval of the display period. Please refer to FIG. 13A and FIG. 13B. FIG. 13A illustrates a timing diagram of the capacitive force sensing touch panel performing force sensing during the blanking interval of the display period; FIG. 13B illustrates a timing diagram of the capacitive force sensing touch panel performing both force sensing and touch sensing during the blanking interval of the display period.

As shown in FIG. 13A, in an embodiment, the force sensing driving signal SFE drives the force sensing electrodes during the blanking interval of the vertical synchronous signal Vsync to perform force sensing; the touch sensing driving signal STH drives the touch sensing electrodes during the blanking interval of the horizontal synchronous signal Hsync to perform touch sensing. As shown in FIG. 13B, in another embodiment, the force sensing driving signal SFE drives the force sensing electrodes during the blanking interval of the vertical synchronous signal Vsync to perform force sensing; the touch sensing driving signal STH also drives the touch sensing electrodes during the blanking interval of the vertical synchronous signal Vsync to perform touch sensing, but not limited to this.

Compared to the prior arts, the capacitive force sensing touch panel of the invention has the following advantages and effects:

(1) Although the touch sensing and the force sensing are both determined according to the capacitance variation, in the invention, a relative upper electrode is used or the electrodes are divided into touch sensing electrodes and force sensing electrodes according to different functions during the force sensing period to avoid the effects caused by the change of the finger pressing area to maintain the accurate sensed capacitance.

(2) The capacitive force sensing touch panel of the invention can be applied to different touch panel structures such as in-cell touch panel structure, on-cell touch panel structure or out-cell touch panel structure.

(3) A force sensing electrode can be disposed between the touch sensing electrode and the liquid crystal module to shield the noise of the liquid crystal module and effectively increase the signal-to-noise ratio of touch sensing.

(4) Touch sensing and force sensing of the capacitive force sensing touch panel can be driven in a time-sharing way and operated during the blanking interval of the display period to avoid the noise interference of the liquid crystal module.

(5) The touch electrodes can be used for touch sensing and force sensing respectively by switching the touch electrode signal without additionally disposing any force sensing electrodes.

(6) The number of channels required can be reduced by two mutual-capacitive electrode layers and since no trace is routed in the active area of the touch panel, the dead zone without any touch function can be avoided; therefore, it can be applied to the middle-size or large-size touch panel.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A capacitive force sensing touch panel, comprising:
a plurality of pixels, and a laminated structure of each pixel comprising:
a first plane;
a second plane disposed above the first plane and parallel to the first plane;
at least a first electrode disposed on the first plane; and
at least a second electrode disposed on the second plane;
wherein the at least one first electrode and the at least one second electrode are selectively driven as a touch sensing electrode or a force sensing electrode respectively.

2. The capacitive force sensing touch panel of claim 1, wherein only the at least one first electrode disposed on the first plane or the at least one second electrode disposed on the second plane is driven as the touch sensing electrode to form a self-capacitive structure.

3. The capacitive force sensing touch panel of claim 1, wherein the at least one first electrode disposed on the first plane and the at least one second electrode disposed on the second plane are both driven as the touch sensing electrodes to form a mutual-capacitive structure.

4. The capacitive force sensing touch panel of claim 1, wherein only the at least one first electrode disposed on the first plane or the at least one second electrode disposed on the second plane is driven as the force sensing electrode.

5. The capacitive force sensing touch panel of claim 1, wherein the at least one first electrode disposed on the first plane and the at least one second electrode disposed on the second plane are both driven as the force sensing electrodes.

6. The capacitive force sensing touch panel of claim 1, wherein the first plane and the second plane are two different planes of the same substrate or planes of two different substrates respectively.

7. The capacitive force sensing touch panel of claim 1, wherein the at least one first electrode disposed on the first plane is driven as the force sensing electrode and the at least one second electrode disposed on the second plane is driven as the touch sensing electrode, so that the touch sensing electrode is disposed above the force sensing electrode.

8. The capacitive force sensing touch panel of claim 1, wherein when the capacitive force sensing touch panel is pressed by a force, a distance between the at least one second electrode disposed on the second plane and the at least one first electrode disposed on the first plane is changed to sense a capacitance variation between the at least one first electrode and the at least one second electrode.

9. The capacitive force sensing touch panel of claim 1, wherein the at least one first electrode disposed on the first plane is driven as a touch sensing electrode by a touch signal, but the at least one second electrode corresponding to a force sensing position receives a ground level or a floating level to be a shielding electrode of a part of the at least one first electrode; when the capacitive force sensing touch panel is pressed by a force, a distance between the at least one second electrode corresponding to a force sensing position and the part of the at least one first electrode is changed to sense a capacitance variation between the at least one first electrode and the at least one second electrode.

10. The capacitive force sensing touch panel of claim 9, wherein touch sensing and force sensing are performed at the same time, but the force sensing position loses a touch sensing function.

11. The capacitive force sensing touch panel of claim 1, wherein the at least one first electrode disposed on the first plane is driven as a touch sensing electrode by a touch signal, but the a part of the at least one first electrode corresponding to a force sensing position receives a ground level, a floating level or a reference voltage and the at least one second electrode corresponding to the force sensing position receives the touch signal; when the capacitive force sensing touch panel is pressed by a force, a distance between the at least one second electrode corresponding to the force sensing position and the part of the at least one first electrode is changed to sense a capacitance variation between the at least one first electrode and the at least one second electrode.

12. The capacitive force sensing touch panel of claim 11, wherein touch sensing and force sensing are performed at the same time, and the force sensing position still has a touch sensing function.

13. The capacitive force sensing touch panel of claim 1, wherein the at least one first electrode disposed on the first plane corresponds to a force sensing position and receives a ground level, a floating level or a reference voltage, the at least one second electrode disposed on the second plane is driven as a touch sensing electrode by a touch signal; when the capacitive force sensing touch panel is pressed by a force, a distance between the at least one first electrode corresponding to the force sensing position and the at least one second electrode is changed to sense a capacitance variation between the at least one first electrode and the at least one second electrode.

14. The capacitive force sensing touch panel of claim 13, wherein touch sensing and force sensing are performed at the same time, and the force sensing position still has a touch sensing function.

15. The capacitive force sensing touch panel of claim 1, wherein touch sensing and force sensing are performed in a time-sharing way, during a touch sensing period, the at least one first electrode disposed on the first plane corresponds to a force sensing position and receives a ground level, a floating level, a reference voltage or a touch signal, the at least one second electrode disposed on the second plane corresponds to the force sensing position and the at least one second electrode is driven as a touch sensing electrode by a touch signal; during a force sensing period, the at least one first electrode disposed on the first plane corresponds to the force sensing position and receives the reference voltage or a force sensing signal, the at least one second electrode disposed on the second plane corresponds to the force sensing position receives the ground level.

16. The capacitive force sensing touch panel of claim 1, wherein the capacitive force sensing touch panel has an out-cell touch panel structure, the laminated structure further comprises a liquid crystal module and a cover lens, and the first plane and the second plane are disposed between the liquid crystal module and the cover lens.

17. The capacitive force sensing touch panel of claim 16, wherein the laminated structure further comprises a first substrate and a second substrate, the first substrate is disposed on an upper surface of the liquid crystal module and the second substrate is disposed on a lower surface of the cover lens, the first plane and the second plane are located at an upper surface of the first substrate and a lower surface of the second substrate respectively.

18. The capacitive force sensing touch panel of claim 16, wherein the laminated structure further comprises a first substrate disposed on an upper surface of the liquid crystal module, and the first plane and the second plane are located at an upper surface of the first substrate and a lower surface of the cover lens respectively.

19. The capacitive force sensing touch panel of claim 16, wherein the laminated structure further comprises a first substrate disposed between the liquid crystal module and the cover lens, and the first plane and the second plane are located at a lower surface and an upper surface of the first substrate respectively.

20. The capacitive force sensing touch panel of claim 1, wherein the capacitive force sensing touch panel has an on-cell touch panel structure, the laminated structure further comprises a liquid crystal module and a cover lens, and the first plane and the second plane are disposed between the liquid crystal module and the cover lens.

21. The capacitive force sensing touch panel of claim 20, wherein the laminated structure further comprises a first substrate disposed on a lower surface of the cover lens, and the first plane and the second plane are located at an upper surface of the liquid crystal module and a lower surface of the first substrate respectively.

22. The capacitive force sensing touch panel of claim 20, wherein the first plane and the second plane are located at an upper surface of the liquid crystal module and a lower surface of the cover lens respectively.

23. The capacitive force sensing touch panel of claim 1, wherein the capacitive force sensing touch panel has an in-cell touch panel structure, the laminated structure further comprises a first transparent layer and a second transparent layer, and the second transparent layer is disposed above the first transparent layer.

24. The capacitive force sensing touch panel of claim 23, wherein the first plane and the second plane are located at an upper surface of the first transparent layer and a lower surface of the second transparent layer respectively.

25. The capacitive force sensing touch panel of claim 23, wherein the first plane and the second plane are located at an upper surface of the first transparent layer and an upper surface of the second transparent layer respectively.

26. The capacitive force sensing touch panel of claim 23, wherein the first plane and the second plane are located at an upper surface and a lower surface of the second transparent layer respectively.

27. The capacitive force sensing touch panel of claim 23, wherein the laminated structure further comprises a polarizer disposed on an upper surface of the second transparent layer, and the first plane and the second plane are located at a lower surface of the second transparent layer and an upper surface of the polarizer respectively.

28. The capacitive force sensing touch panel of claim 23, wherein the laminated structure further comprises a polarizer and a cover lens, the polarizer is disposed on an upper surface of the second transparent layer and the cover lens is disposed above the polarizer, and the first plane and the second plane are located at a lower surface of the second transparent layer and a lower surface of the cover lens respectively.

29. The capacitive force sensing touch panel of claim 1, wherein a touch and force sensing mode of the capacitive force sensing touch panel and a display mode of the capacitive force sensing touch panel are driven in a time-sharing way, and the capacitive force sensing touch panel is operated in the touch and force sensing mode during a blanking interval of a display period and operated in the display mode during a display interval of the display period.

30. The capacitive force sensing touch panel of claim 29, wherein the blanking interval comprises at least one of a vertical blanking interval (VBI), a horizontal blanking interval (HBI), and a long horizontal blanking interval (LHBI); a time length of the LHBI is equal to or larger than a time length of the HBI; the LHBI is obtained by redistributing a plurality of HBIs or the LHBI comprises the VBI.

31. The capacitive force sensing touch panel of claim 1, wherein a force sensing mode of the capacitive force sensing touch panel and a display mode of the capacitive force sensing touch panel are driven in a time-sharing way, and the capacitive force sensing touch panel is operated in the force sensing mode during a blanking interval of a display period and operated in the display mode and a touch sensing mode at the same time during a display interval of the display period.

32. The capacitive force sensing touch panel of claim 1, wherein when the first conductive layer and the second conductive layer are driven as the touch sensing electrode, the first conductive layer and the second conductive layer comprise at least one driving electrode and at least one sensing electrode respectively to receive a driving signal and a sensing signal respectively.

33. The capacitive force sensing touch panel of claim 1, wherein when the first conductive layer and the second conductive layer are driven as the force sensing electrode, the first conductive layer comprises at least one driving electrode and receives a force sensing signal, a driving signal or a reference voltage, and the second conductive layer comprises at least one sensing electrode and receives a ground level or a floating level.

34. The capacitive force sensing touch panel of claim 1, wherein when the first conductive layer and the second conductive layer are driven as the touch sensing electrode, the first conductive layer comprises at least one driving electrode and receives a driving signal, and the second conductive layer comprises at least one sensing electrode and at least one dummy electrode interlaced to receive a sensing signal and a floating level respectively.

35. The capacitive force sensing touch panel of claim 1, wherein when the first conductive layer and the second conductive layer are driven as the force sensing electrode, the first conductive layer comprises at least one driving electrode and receives a force sensing signal, a driving signal or a reference voltage, and the second conductive layer comprises at least one sensing electrode and at least one dummy electrode interlaced to receive a ground level or a floating level at the same time.

36. The capacitive force sensing touch panel of claim 1, wherein the at least one first electrode disposed on the first plane comprises a first direction first electrode and a second direction first electrode to form a self-capacitive structure or a mutual-capacitive structure; the at least one second electrode disposed on the second plane comprises a first direction second electrode and a second direction second electrode to form a mutual-capacitive structure.

37. The capacitive force sensing touch panel of claim 36, wherein a pitch between the at least one first electrode disposed on the first plane is larger than or equal to a pitch between the at least one second electrode disposed on the second plane.

38. The capacitive force sensing touch panel of claim 36, wherein when the capacitive force sensing touch panel is operated in a touch sensing mode, the first direction second electrode and the second direction second electrode receive a touch driving signal and a touch sensing signal respectively to perform mutual-capacitive sensing, and the first direction first electrode and the second direction first electrode receive a floating level, a ground level or a fixed level.

39. The capacitive force sensing touch panel of claim 36, wherein when the capacitive force sensing touch panel is operated in a force sensing mode, the first direction second electrode and the second direction second electrode receive a fixed reference voltage or a ground level to be a shielding electrode, and the first direction first electrode and the second direction first electrode receive the same force sensing voltage to sense a self-capacitance variation, or the first direction first electrode and the second direction first electrode receive different force sensing voltages respectively to sense a mutual-capacitance variation.
